(19) United States
(12) Patent Application Publication
(10) Pub. No.: US 2017/0211780 A1
(43) Pub. Date: Jul. 27, 2017

(54) A LIGHTING SYSTEM AND A LIGHT COLLIMATION MODULE

(71) Applicant: 3M INNOVATIVE PROPERTIES COMPANY, St. Paul, MN (US)

(72) Inventor: Andrew T. Tio, Singapore (SG)

(21) Appl. No.: 15/328,264

(22) PCT Filed: Aug. 24, 2015
(86) PCT No.: PCT/US2015/046513

§ 371 Date: Jan. 23, 2017

(30) Foreign Application Priority Data
Aug. 24, 2014 (SG) 10201405166T

(51) Int. Cl. F21V 7/00; F21V 29/70; F21V 23/00; F21V 5/04

(52) U.S. Cl. CPC F21V 7/0008; F21V 5/04; F21V 29/70; F21V 23/003; F21Y 2115/10

(57) ABSTRACT

A lighting system comprising: a duct providing a light transport passage for transporting light along a propagation direction parallel to a longitudinal axis of the duct, the duct comprising one or more light output surfaces through which light may be emitted, a light collimator having an input end and an output end, a light source arranged to direct light into the input end of the light collimator, a heat sink thermally coupled to the light source, and driver circuit for powering the light source, wherein at least one of the light collimator, light source, heat sink and driver circuit is arranged away from the longitudinal axis of the duct.

### FIELD OF TECHNOLOGY

The invention relates to lighting systems, and more particularly to ducted lighting systems.

### BACKGROUND

The long-distance transport of visible light can be facilitated by mirror-lined light ducts and is employed in architectural lighting to deliver light throughout the interior parts of buildings. Mirror-lined ducts also provide advantages of large cross-sectional area and large numerical aperture (enabling larger fluxes with less concentration), a robust and clear propagation medium (that is, air) that leads to both lower attenuation and longer lifetimes, and a potentially lower weight per unit of light flux transported. Mirror-lined light ducts can be uniquely enabled by the use of 3M optical films, including mirror films such as enhanced specular reflector (ESR) films that have greater than 98% specular reflectivity across the visible spectrum of light.

Concurrently, LEDs are increasingly deployed as an energy saving replacement for traditional tungsten or fluorescent lighting systems. Lamps installed with LEDs typically have LEDs mounted on a plate, which is in turn affixed on a wall or ceiling, and the LEDs are arranged directly behind the light output surface of the lamp. LED lighting systems that use LED strips for a large room may consequently require installation of a plurality of LED strips throughout the room, along with sizeable driver circuit units for powering the LEDs. Heat generated by individual LED units on the strip requires effective dissipation to avoid overheating which could affect the lifespan of the LED units, but limited space exists in lighting systems, such as mirror-lined light ducts, to implement effective heat dissipation devices.

Given the myriad of competing factors such as those described above influencing the design of lighting systems and the ever increasing stringency end users place on both cost and performance, the need continues to exist for innovative approaches in developing new solutions.

### SUMMARY OF INVENTION

In one aspect, a lighting system is disclosed comprising a duct providing a light transport passage for transporting light along a propagation direction through the duct, the duct comprising a longitudinal axis and one or more light output surfaces through which light may be emitted, a light collimator having an input end and an output end, a light source arranged to direct light into the input end of the light collimator, a heat sink thermally coupled to the light source, and driver circuit for powering the light source, wherein at least one of the light collimator, light source, heat sink and driver circuit is arranged away from the longitudinal axis of the duct.

In another aspect, a light collimation module is disclosed, comprising a light collimator coupled to a duct, the light collimation module usable in a lighting system comprising: a duct providing a light transport passage for transporting light along a propagation direction through the duct, the duct comprising a longitudinal axis and one or more light output surfaces through which light may be emitted, a light collimator having an input end and an output end, a light source arranged to direct light into the input end of the light collimator, a heat sink thermally coupled to the light source, and driver circuit for powering the light source, wherein at least one of the light collimator, light source, heat sink and driver circuit is arranged away from the longitudinal axis of the duct.

These and other aspects of the invention are described in the detailed description below. In no event should the above summary be construed as a limitation on the claimed subject matter which is defined solely by the claims as set forth herein.

### BRIEF DESCRIPTION OF THE DRAWINGS

Throughout the specification, reference is made to the appended drawings, where like reference numerals designate like elements, wherein:

FIG. 1 depicts a lighting system mounted near a door.

FIG. 2 shows a cross sectional view of a lighting system with driver circuit arranged at an angle of 90° to the duct's longitudinal axis.

FIG. 3 shows a cross sectional view of a lighting system with light engine arranged at an angle of 90° to the duct's longitudinal axis.

FIG. 4 shows a cross sectional view of a lighting system with two light engines connected by an E-shaped joint to a duct.

FIG. 5 shows a cross sectional view of a lighting system with two light engines arranged at opposite ends of a duct.

FIG. 6 shows a cross sectional view of a lighting system with light engine arranged vertically.

FIG. 7 shows a cross sectional view of a lighting system with two light engines arranged vertically at opposite ends of a duct.

FIG. 8 is a cross sectional view of a light engine.

FIG. 9 is a cross sectional view of a light engine with driver circuit arranged at an angle of 90° to the heat sink and light collimator.

FIG. 10 is a perspective view of a light engine.

FIG. 11 is a perspective view of a light collimator.

FIG. 12 is a perspective view of a light engine housing.

FIG. 13 is a top view of a duct section.

FIG. 14 is a perspective view of a heat sink.

FIG. 15 is a perspective view of a multilayer optical stack of the output surface of a duct section.

FIG. 16 is a cross sectional view of the multilayer optical stack of the output surface of a duct section.

FIG. 17 is a cross sectional view of a lighting system wherein the light output surface comprises mirrors.

FIG. 18 is a cross sectional view of a lighting system having modular construction, comprising light engine, light collimation module and ducts.

FIG. 19 is a cross sectional view of a lighting system in which the light collimator comprises a plurality of light collimators arranged together.

FIG. 20 shows a 2 by 2 layout of light collimators in a square duct.

The figures are not necessarily drawn to scale. However, it will be understood that the use of a numeral to refer to a component in a given figure is not intended to limit the component in another figure labeled with the same number.

### DETAILED DESCRIPTION

The present disclosure describes a lighting system employing mirror-lined ducts designed to be compact and hence suitable for use in relatively cramped spaces, such as end-sections of a corridor. This is achieved by locating terminal components of the lighting system, such as the light collimator, light source, heat sink and driver circuit, away from the longitudinal axis of the duct. In other words, rather than arranging the these terminal components in a single file, i.e. in a straight line along the duct's longitudinal axis, which results in a lengthy terminal section, it is advantageous to arrange such components away from the duct's longitudinal axis, such as arranging the components at an angle of 90° or 180° to the longitudinal axis of the duct. In certain embodiments, such an arrangement results in the light source being emitted at 90° or 180° to the intended light propagation direction, so suitable joints or bends may be used to efficiently direct light from the light source into the duct, or from one duct section to another.

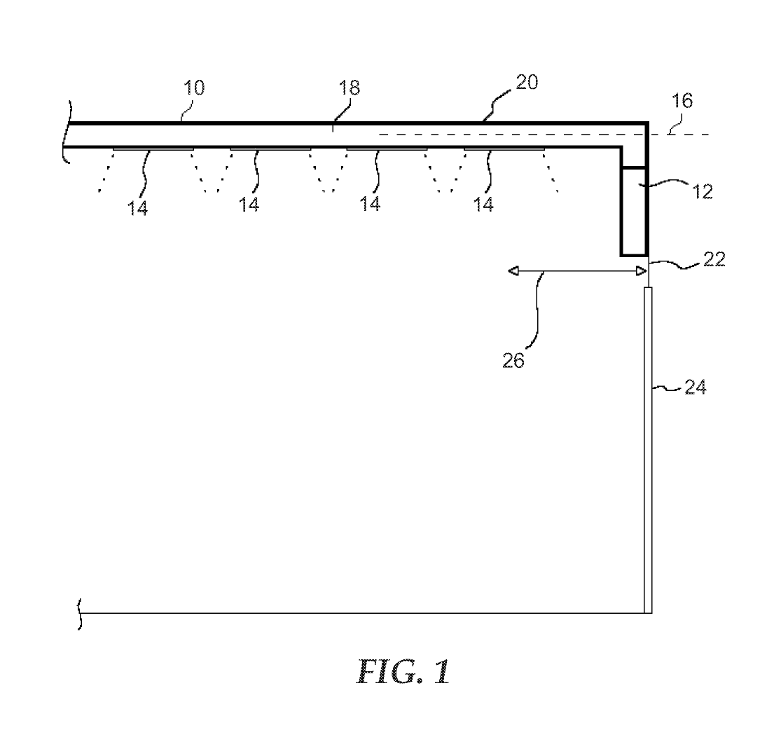

Referring to FIG. 1, a lighting system 10 comprising terminal component 12 and light output surfaces 14 is mounted onto ceiling 20, which may be along a corridor of an office or residential unit. The terminal component 12 may comprise, for example, the light engine of the lighting system and may include any one or a combination of a light collimator, light source, heat sink and driver circuit. Terminal component 12 is arranged away from (i.e. it does not lie along) the longitudinal axis 16 of the duct 18 of the lighting system 10, and is mounted on vertical wall surface 22. As terminal component 12 is displaced to the side, the distance between door 24 and the first light output surface 14, as indicated by arrow 26, is shortened, enabling the vicinity in front of the door to be more brightly illuminated, and more generally, enabling the light output surface 14 to be brought close to a wall at the end of a corridor, or a room.

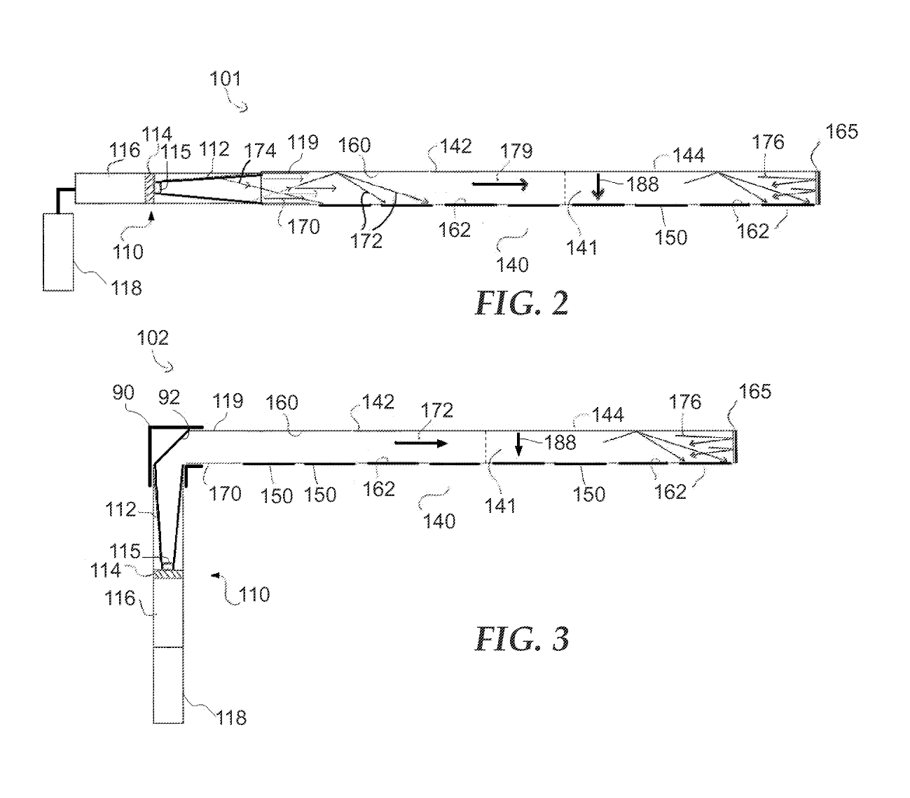

The arrangement of the terminal component of the lighting system away from duct's longitudinal axis may be achieved in several ways. FIG. 2 shows a lighting system 100 in which light engine 110 is connected to a duct 140. Light engine 110 comprises a light collimator 112, which has one end facing duct 140, and another end facing LED light source 114. Alternatively, LED light source 114 may be, for example, a plasma light source, a halogen light source, a high intensity discharge lamp, or any other suitable light source. An LED light source is used in this and other examples for illustrative purposes. LED light source 114 is arranged to direct light into the input end of the light collimator, so that light exiting the light collimator 112 and entering the duct 140 is substantially collimated. In this embodiment, light collimator 112, LED light source 114 comprising an LED array 115, and heat sink 116 are arranged along the longitudinal axis of the duct, while driver circuit 118 for powering the LED light source 114 is arranged away from the longitudinal axis of the duct 140, such that it does not form a straight line or a single file with the rest of the light engine 110, but rather, displaced at an angle of 90° to the longitudinal axis of the duct 140.

In FIG. 2, LED light source 114 is thermally coupled to a heat sink 116, which helps to dissipate heat generated from the LED light source 114 during operation. For example, the LED light source 114 may be mounted onto a surface of the heat sink 116. Thermal interface materials, also known as heat sink compounds or thermal grease, may be used to provide improved thermal coupling between the LED light source 114 and the heat sink 116. LED light source 114 may comprise an LED array 115 arranged on a surface of heat sink 116. and may connected In an exemplary embodiment, the heat sink has the shape of a rectangular cuboid, the longest dimension of the rectangular cuboid, i.e. the length, being configured to extend away from the collimator 112. In this manner, exposure of heat sensitive parts of the collimator to the heat generated by the LED array 115 is reduced due to the conduction of heat in an axial direction away from the LED array 115 along the length of the heat sink 116.

The duct 140 defines a light transport passage 141. The duct 140 may be made up of 1, 2, 3, 4, 5 or more duct sections. Each duct section may be attached onto the ceiling or wall via nails or adhesive, or via fastening clips, and are coupled to each other via fastening clips or alternatively, each duct section may comprise mating end portions so that one duct section can be telescopically fitted to another duct section. Any other means of coupling duct sections together can also be used, where preferably the adjoining surfaces are well-fitting and do not suffer from light leaks.

Duct 140 may comprise individual duct sections 142, 144. The internal surface of each duct section 142, 144 is lined with a reflective material 160 to help reflect light within the duct 140. Examples of usable reflective materials include polished metal surfaces or specialty materials such as 3M Enhanced Specular Reflective (ESR) films. Other embodiments include mirror-lined ducts, such as reflective aluminum ducts, reflective acrylic ducts and optical grade polycarbonate ducts, or any other material capable of providing at least 90% reflectance, or more generally, at least 80% reflectance, or at the minimum 70% reflectance. Of the light rays that exit the light collimator 112, a substantial amount comprises collimated light rays 170. Non-collimated light rays 172 may be derived from light rays that are reflected off the internal surfaces of duct 140, or light rays 174 that are reflected off the surface of the light collimator 112. Light is hence propagated longitudinally through the duct, or in other words, light is transported along a propagation direction, as represented by arrow 179, that is parallel to the longitudinal axis of the duct.

Light exits the duct 140 via light output surfaces 150 located on the duct's surface. In one embodiment, each light output surface is arranged in a plane parallel to the longitudinal axis of the duct. Light therefore exits the duct in a direction, as represented by arrow 188, that is transverse to its propagation direction 179. Optical right angle films, such as 3M Transmissive Right Angle Films II (TRAF) may be used for this purpose. Advantageously, a single LED light source may be used to illuminate a duct ranging from several meters long to several tens of meters long, or preferably about ten duct sections of 1.2 meters each, i.e. total of 12 meters. Light rays 176 arriving at the end of the duct 140 are reflected off surface 165 and are recycled.

FIG. 3 shows an embodiment of a lighting system 102 in which light engine 110 comprising light collimator 112, LED light source 114 comprising an LED array 115, heat sink 116 and driver circuit 118 are arranged in a single file and arranged away from the longitudinal axis of the duct 140. Since light emitted by the LED light source 114 is at an angle of 90° to the longitudinal axis of the duct 140, lighting system 101 comprises a light collimator joint 102 which alters the propagation direction of light in the lighting system. Joint 102 may comprise a reflective surface 102, such as a light reflector e.g. mirror, which reflects light emitted by light engine 110, so that light is propagated in a second direction which is different from the original propagation direction along the longitudinal axis of the duct as indicated by arrow 179. In this embodiment, light engine 110 comprises light collimator 112, LED light source 114 comprising an LED array 115, heat sink 116 and driver circuit 118. Duct 140 comprises duct sections 144, 142. Light rays exit duct 140 via light output surfaces 150.

In general, joints may adopt any suitable configuration needed to connect components of the lighting system together and to alter the propagation direction of light in the lighting system from one component to the next. Techniques and apparatus used to extract and distribute light in ducts using joints and other light distribution components have been described, for example, in U.S. Pat. No. 8,251,527 entitled LIGHT DUCT BEND; Patent Publication Nos. US2012/0057350 entitled SWITCHABLE LIGHT DUCT EXTRACTION; WO2012/138503 entitled LIGHT DUCT TEE EXTRACTOR; WO2012/138595 entitled LIGHT DUCT TEE SPLITTER; WO2014/070498 entitled RECTANGULAR LIGHT DUCT EXTRACTION; and WO2014/168823 entitled ILLUMINATED LIGHT DUCT JOINT. In some embodiments, joints may be L-shaped or U-shaped for connecting two components together; joints may be T-shaped or E-shaped for connecting three components together, and so on, depending on the layout of the duct and light engine. Within the joints, light reflectors may be positioned to reflect light from the light source into the duct. In the context of this description, the term “joint” has the same meaning as the term “bend” and is used interchangeably throughout the description. Joints for connecting a light collimator to a duct is herein termed a “light collimator joint” or “light collimator bend”, and joints for connecting sections of the duct together are termed “duct joints” or “duct bends”.

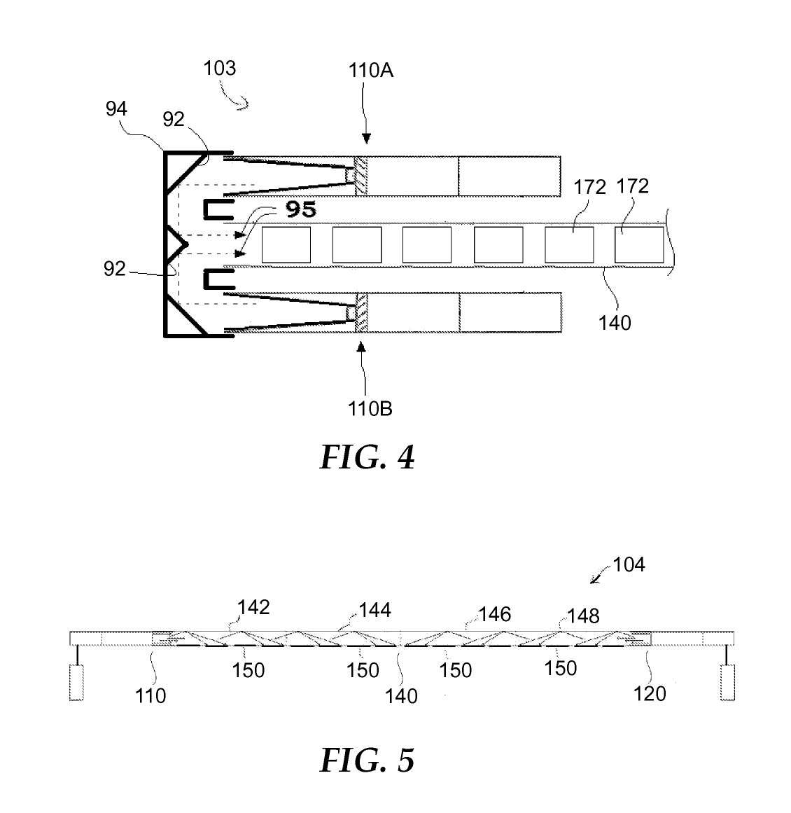

FIG. 4 shows an embodiment in which lighting system 103 comprises a E-shaped light collimator joint 94 which connects the two light engines 110A, 110B to the duct 140. Each of light engine may comprise a light collimator, LED light source comprising an LED array, heat sink and driver circuit arranged in a single file, and at an angle of 180° to the longitudinal axis of the duct, i.e. it is positioned parallel to the longitudinal axis of the duct. Joint 94 comprises light reflectors 92 which are arranged such that light emitted from the light engines are directed along the propagation direction indicated by arrows 106 into duct 140, and exits duct 140 via light output surfaces 150. This embodiment provides a highly compact layout for a dual-light engine lighting system, and enables the entire lighting system to be mounted to the ceiling.

FIG. 5 shows an embodiment in which lighting system 104 comprises two light engines, wherein light engine 120 is arranged at an opposing end of the duct 140, opposite light engine 110. Similar to FIG. 1, light engine components comprising light collimator, LED light source comprising an LED array, and heat sink may be arranged along the longitudinal axis of the duct, while driver circuit for powering the LED light source may be arranged away from the longitudinal axis of the duct 140. In this configuration, duct 140 may comprise a plurality of duct sections 142, 144, 146, 148. The provision of two light engines is advantageous for illuminating a long duct, which may in various instances be 20 meters, 30 meters, or more in length, or in certain embodiments, about 20 duct sections of 1.2 meters, i.e. 24 meters. This embodiment may be useful for illuminating long corridors or passageways.

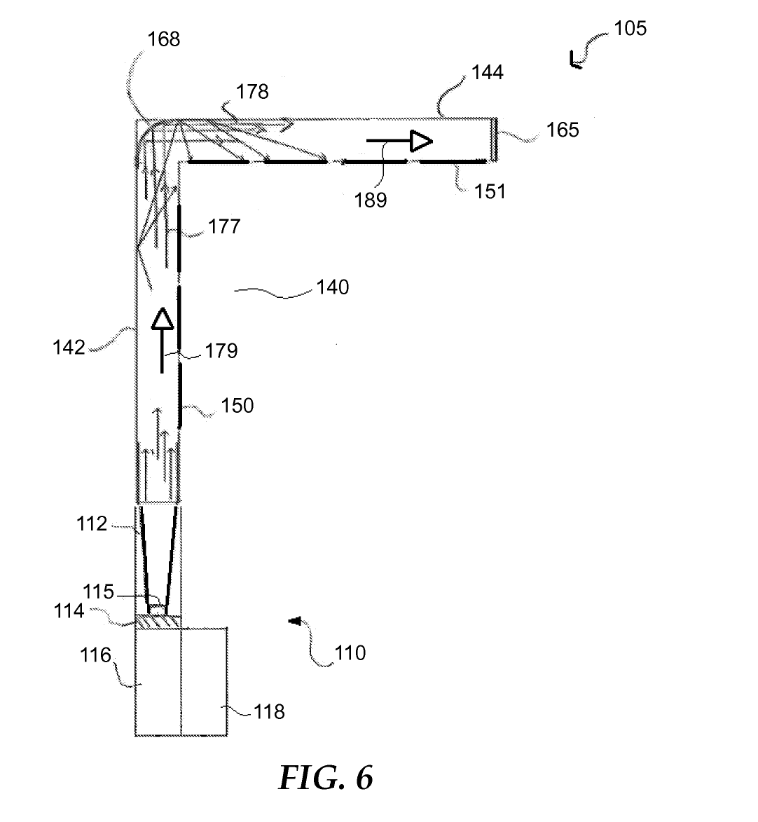

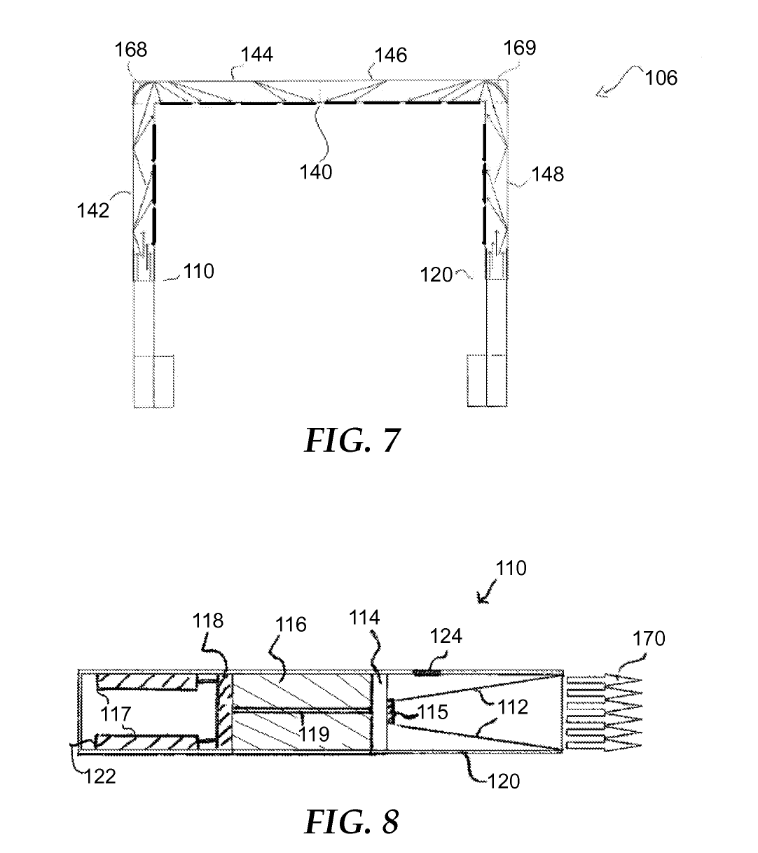

Displacement of the light engine components away from the longitudinal axis of the duct may also be employed to reduce the vertical height of the lighting system in embodiments in which the light engine is vertically mounted. FIG. 6 shows a lighting system 105 in which light engine 110 comprises light collimator 112, light source 114 comprising an LED array 115, and heat sink 116 arranged in a single file along the longitudinal axis of duct section 142 of light duct 140. Driver circuit 118 is arranged away from the longitudinal axis of duct section 142, e.g. arranged side-by-side with the heat sink 116. In this example, bend 168 comprising a light reflector connects duct section 142 to duct section 144, enabling light to be directed from a first propagation direction 179 to a second propagation direction 189. FIG. 7 shows a similar layout in which lighting system 106 is provided with two vertically arranged light engines 110, 120 which are connected to vertical duct sections 142, 148, which are in turn connected to horizontal duct sections 144, 146 via bends 168, 169. Light from light engine 110 is propagated from light duct section 142 to 144, 146 and 148, whereas light from light engine 120 is propagated from light duct section 148 to 146, 144 and 142. In general, embodiments employing vertically arranged light engines and duct sections enable near ground-level arrangement of the electrical components such as the driver circuit and light source, allowing any malfunctioned parts of the light engine to be easily replaced. Bends 168, 169 are duct bends with appropriate reflectors included and may be configured in an L-shape, T-shape or E-shape.

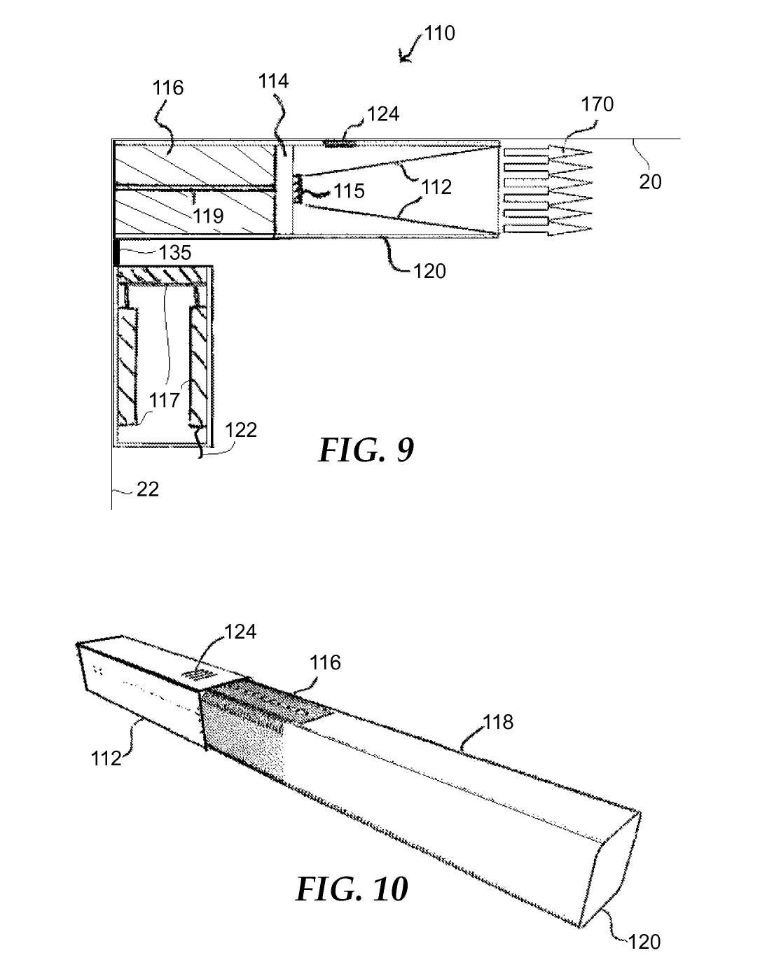

FIG. 8 and FIG. 9 are close-up views embodiments of light engine 110 usable in embodiments of a lighting system. In FIG. 8, light collimator 112, light source 114, and heat sink 116 are arranged in a single file. Light collimator 112 is used to collimate light produced by the LED light source 114. LED light source 114 may comprise an LED array 115 and a driver circuit 118 for powering the LED array. In the embodiment shown in FIG. 5, LED array 115 is arranged on a first surface of the heat sink 116, and a driver circuit 118 for powering the LED array is arranged or sandwiched on a second surface of the heat sink, so that the driver circuit 118 is separated from the LED array 115 by the heat sink 116. Wiring 119 extends from the driver circuit 118 to the LED array 115. The light engine may be enclosed in a light engine housing 120. The driver circuit or sub-components thereof may also be placed on the light engine housing 120 at positions 117. Wiring 122 serves to connect the driver circuit to an external electrical source. By arranging the component of the light engine 110 in this manner, heat generating components of the light engine 110 are optimally separated from each other, as well as separated from the duct 140 and collimator 112, each of which may comprise heat sensitive optical films. This arrangement may be helpful for high power LED arrays which can generate sufficient heat to damage the wiring and components of the driver circuit 118 if placed in close proximity. The driver circuit may furthermore heat generating components, imposing an additional thermal load on the heat sink. Hence, positioning driver circuit 118 away from the LED array 115 may further optimize the heat distribution across the light engine 110. The light engine 110 may be placed within a housing as depicted in FIG. 10.

FIG. 9 shows a light engine 110 in which light collimator 112, light source 114, and heat sink 116 are arranged in a single file and mounted to the ceiling 20, while driver circuit 118, comprising various electrical components 117, is arranged on vertical wall 22 adjacent to the ceiling 20, at 90° to the single file.

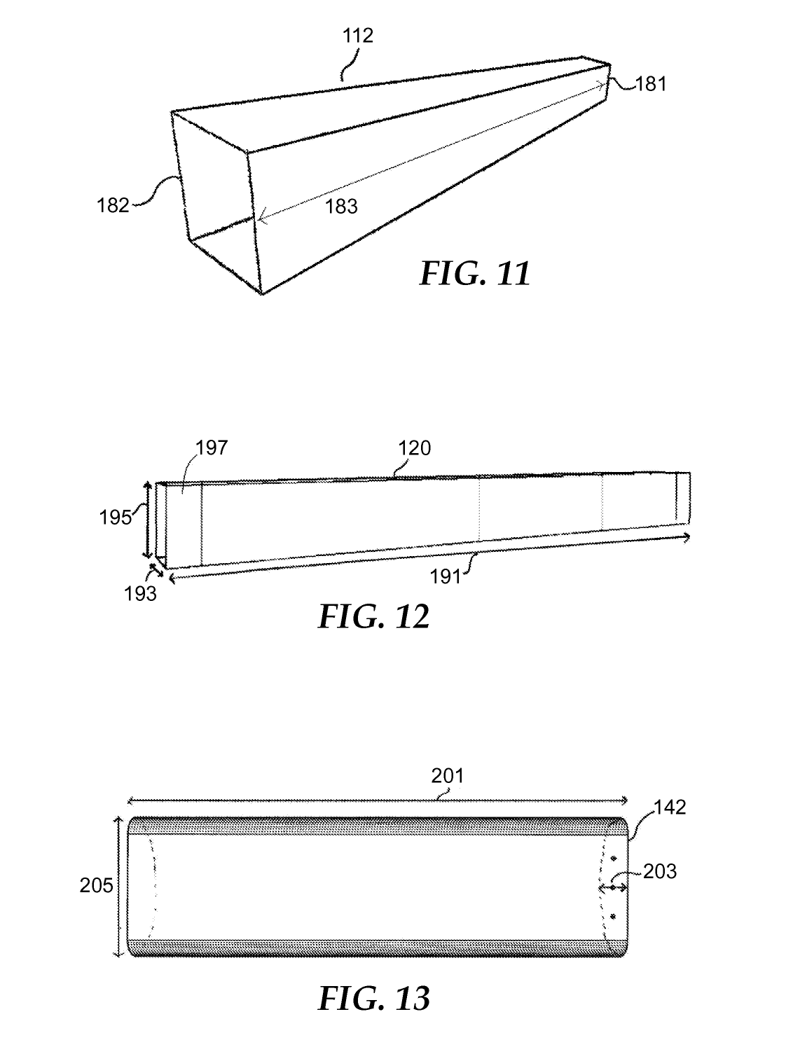

In some embodiments, the light collimator 112 is configured in the shape of a conical or a pyramidal frustum, sometimes referred to as a reflective cone or pyramid. In other words, it is configured as a cone or pyramid structure in which the pointed end is removed, thereby having an opening 181 that serves as the input end of the light collimator and is attached to the heat sink. The large opening 182 serves as the output end for collimated light to exit. FIG. 11 shows an example of a light collimator in the form of a conical frustum. Length 183 may be determined by any empirically determined design rule for achieving optimal light collimation, an example of which is described below.

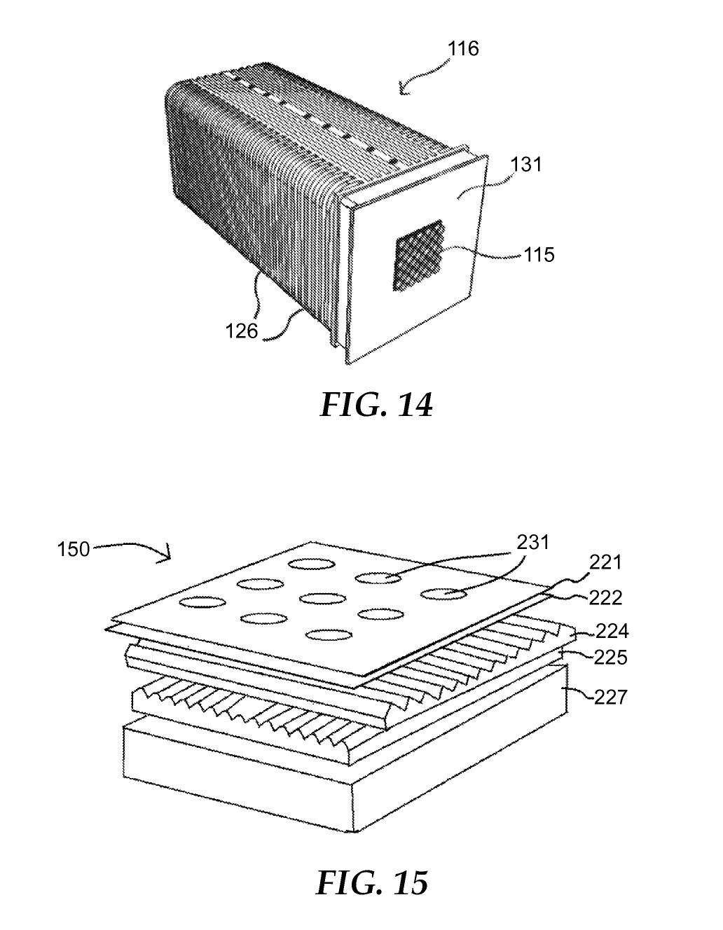

In order to increase the surface area for heat dissipation, the light engine housing may comprise in an exemplary embodiment a metal casing that is thermally coupled to the heat sink 116, to enable the entire light engine housing to function as a heat sink of sorts. In some embodiments, the light engine housing may be configured as a secondary heat sink, to aid in the cooling of heat sink 116. Optionally, the heat sink 116 may comprise grooves 126 as shown in FIG. 14. It may comprise fins that are exposed outside of the metal casing to enable increased cooling of the heat sink. In a preferred embodiment, the heat sink fins are arranged vertically to facilitate natural convection. The light engine housing 120 may furthermore be provided with slots 124 to enable hot air to escape, hence further cooling the light engine.

In order to provide the light engine 110 with an appearance that is similar to the duct—a desirable goal from an aesthetic perspective—at least one of the length, depth or width of the light engine housing 120, as represented by arrows 191, 193, 195 in FIG. 12 comprises the same dimension as that of, respectively, the length, depth or width of the duct sections, as shown by arrows 201, 203, 205 in FIG. 13. In addition, the light engine housing 120 may be painted or provided with decorative elements similar to that used for the duct. In this manner, the light engine housing 120 appears similar to the duct sections, giving a more uniform external appearance. In architectural lighting, where visual aesthetic qualities of lighting systems are an important consideration in the design of a building or a room, the single file arrangement of the light engine components enables visual similarity to be achieved, avoiding an overall unaesthetic appearance in which the light engine looks conspicuously different from the light duct. In this embodiment, the portion of the light engine housing 120 for enclosing the light collimator is provided with an extended portion 197 to enable it to be matingly fitted into a duct section.

LED array 115 may be a 3×3, 4×4, 5×5, or 6×6 LED array or any other size or configuration, delivering in various instances, a total of 5000, 10000, or 15000 or more lumens of light per LED array. As shown in FIG. 14, the LED array 115 is arranged on a surface 131 of the heat sink 116, which may be a polished, white or reflective surface to help recycle light. In certain embodiments, the dimensions of an LED array may be 15 mm×15 mm, 20 mm×20 mm, 25 mm×25 mm, or 30 mm×30 mm. Larger LED arrays may be used as well.

The following design rules for the light engine yielded favorable performance in the operation of the lighting system:

Size of the LED array=A×B

Area of output end of light collimator=(3A×3B)

Collimator length=12×B

where A and B represents the dimensions of the edge of a square or rectangular LED array. To achieve a uniform appearance for the light engine and duct, the cross section of the duct may be designed to correspond to the same shape and size of the output end of the light collimator. Accordingly, it has roughly the dimensions of 3A×3B, and may be a square or a rectangle. Notwithstanding the above, a duct with circular or elliptical cross section may also be used if the light collimator has the shape of a conical frustum.

### Example 1

Taking an LED array that is 25 mm×25 mm in size as an example, the above design rule requires the area of the input end of the light collimator to be about 25 mm×25 mm in size. Correspondingly, the output end of the light collimator is designed to be 75 mm×75 mm in size. The length of the light collimator may be designed to be 300 mm. Since each duct is about 1.2 meters in length, in order for the light engine housing 120 to have the same length, the heat sink and driver circuit portion of the light engine may set to about 900 mm in length.

### Example 2

Taking an LED array that is 25 mm×25 mm in size as an example, the above design rule requires the area of the input end of the light collimator to be about 25 mm×25 mm in size. Correspondingly, the output end of the light collimator is designed to be 75 mm×75 mm in size. The length of the light collimator may be designed to be 360 mm. Since each duct is about 1.2 meters in length, in order for the light engine housing 120 to have the same length, the heat sink and driver circuit portion of the light engine may set to about 840 mm in length.

### Example 3

Taking an LED array that is 15 mm×15 mm in size as an example, the above design rule requires the area of the input end of the light collimator to be about 15 mm×15 mm in size. Correspondingly, the output end of the light collimator is designed to be 45 mm×45 mm in size. The length of the light collimator may be designed to be about 180 mm. Since each duct is about 1.2 meters in length, in order for the light engine housing 120 to have the same length, the heat sink and driver circuit portion of the light engine may set to about 102 mm in length.

The above examples illustrate the use of one design rule which is by no means necessary or optimal for the operation of the lighting system. Other design rules may be applied depending on space limitations, size specifications of the lighting system, and the characteristics of the light source, for example.

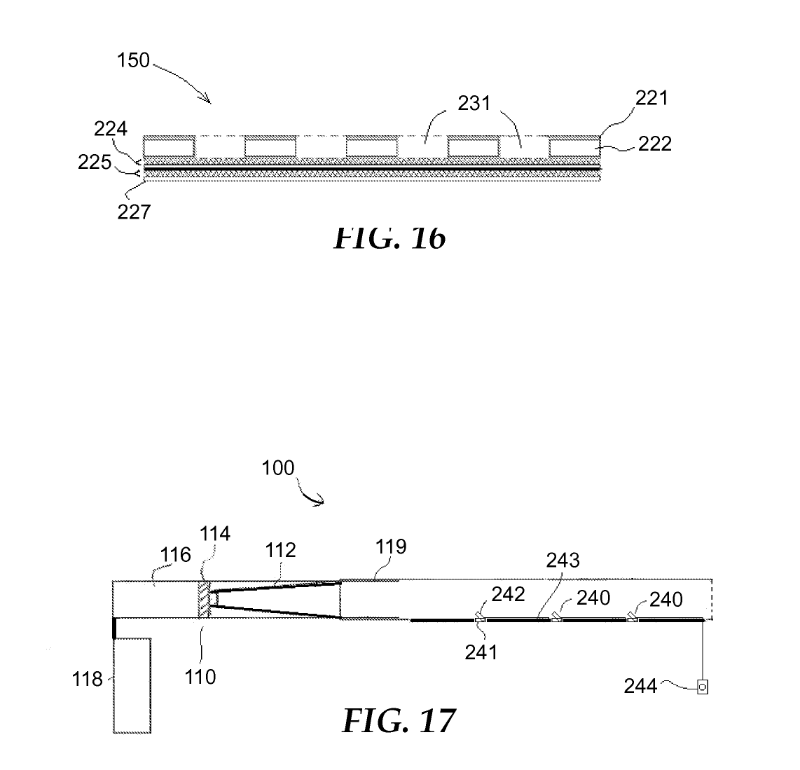

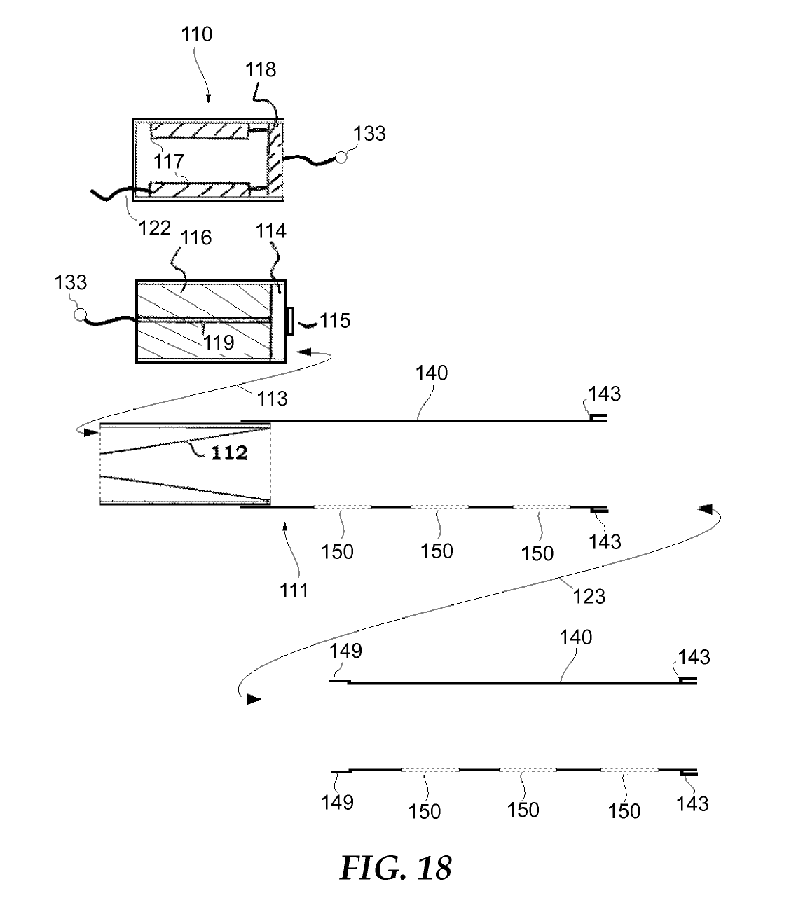

FIGS. 15 and 16 show, respectively, a perspective view and a cross sectional view of the layer structure of a light output surface 150 of a duct section according to an embodiment. In this embodiment, the light output surface 150 comprises a reflective layer arranged to face the duct, the reflective layer having one or more perforations for transmitting light, a polished metal substrate layer having one or more perforations aligned to the perforations of the reflective layer, and one or more optical films arranged over the perforations for processing light leaving the duct. In general, the light output surface performs the dual function of extracting light from the duct, and recycling the remaining light back into the duct for further transmission. For this purpose, the inner most layer may comprise a perforated reflective sheet 221. Commercially available examples include 3M Vikuiti™ Enhanced Specular Reflectors. Perforated reflective sheet 221 is laminated on a polished metal layer 222 comprising corresponding perforations 231 aligned to the perforations of the reflective sheet 221. An example of the polished metal layer comprises an aluminum layer, which is lightweight and capable of being polished. The aluminum layer acts as a support substrate and also provides a suitably reflective surface for reflecting light. Light leaves the output surface 150 via perforations 231. The polished metal layer is attached, via suitable optical adhesives, such as 3M Optically Clear Adhesive 8211/8212/8213/8214/8215 to name a few examples, to a light turning film 224. Light turning films are commercially available as the 3M Vikuiti™ Turning Films series, comprising microreplicated prismatic films for redirecting light toward a direction substantially transverse to the propagation direction 179 as shown in FIG. 1. A specific example is the 3M Transmissive Right Angle Film II (TRAF). Light turning film 224 is in turn attached to a light steering film 225 which may be selected from birefringent films or polarizing films. Optionally, a protective sheet may be provided beneath light turning film 224. This embodiment provides a low cost alternative to conventional optical film stacks that require the use of polycarbonate substrates, which in some cases may cost up to 40% of the bill of materials for an optical plate. This embodiment also provides the benefits of better optical performance, particularly in terms of transmittance as exiting light passes through a thinner optical film stack, and less costly manufacturing since the lamination of optical adhesives to a polycarbonate sheet is avoided.

Further embodiments of the invention are described in the following paragraphs.

### Light Output Surface.

To provide a simple light output surface with good light output performance, it may be preferable to use any transparent substrate for the light output surface, optionally combined with a suitable optical film component that is appropriate for the desired performance, such as a diffuser layer, or a polarizer. For example, to achieve good brightness, the light output surface may comprise a brightness enhancement film. A commercially available example is the 3M Vikuiti™ Brightness Enhancement Film (BEF), comprising optical films with prismatic structures microreplicated throughout the film may be used to increase reflection and refraction of light rays. Another type of optical film that may be used to enhance light output is a reflective polarizer brightness enhancement film. A commercial example is the 3M Vikuiti™ Dual Brightness Enhancement Film (DBEF). Optionally, different layer arrangements of BEF and DBEF may be used: one may deploy an individual layer of BEF for the light output surface, or an individual layer of DBEF, or a plurality of BEF layers, or a plurality of DBEF layers, or a combination of BEF and DBEF layers. Additionally, light diffuser films may be used in conjunction with BEF and DBEF films to diffuse incident light from a light source. Commercially available examples include 3M Envision™ Diffuser Films 3735-50 or 3735-60. In daylight applications, 3M Day Light films DF2000 comprising a polymeric film that provides high luminous reflectivity may be used. As described in foregoing paragraphs, light turning films such as 3M Transmissive Right Angle Film II (TRAF) may be used. These films may be used singly, or in combination. For structural support, each optical film layer or multi-layer film stack may be affixed on transparent glass or polycarbonate or other equivalent transparent substrate. 3M Optically Clear Adhesives (OCA) may optionally be used to provide adhesion between the optical layers and/or substrates; mechanical fastening of individual optical layers may be done as an alternative to optically clear adhesives; as a further alternative, the margins of the optical film layer contacting the substrate may simply be provided with double sided adhesive tape without interfering with light transmission through the optical layer. An alternative that dispenses with the use of a transparent substrate is to have the optical film layer stiffened by providing a layer of polyethylene terephthalate (PET), or biaxially oriented polypropylene film (BOPP), or cast polypropylene on the optical film.

Alternative to the use of optical films for the light output surface is the use of reflectors, e.g. conventional mirrors. In one embodiment, the duct comprises a plurality of light output surfaces, each light output surface comprising a mirror capable of being actuated to a position in which light transmitted through the duct is incident on the mirror and reflected out of the duct. A mirror may be mounted at each light output surface and may be mechanically actuated to reflect light out of the duct. The mirrors may be tilted at any desired angle to reflect light out of the light duct. Referring to FIG. 17, mirrors 240 may be mounted on a hinge at each light output surface. The mirrors may be in a closed position 241 when lights are not in use, or in an open position 242 when lights are in use, wherein the mirror is tilted to reflect incident light out of the duct. The mirrors may be connected by connecting rods 243 to a central control knob 244 in order to be manually actuated between the open and close positions. Optionally, an electronic motor may be used to actuate the mirrors. The mirrors may be arranged in a staggered layout (e.g. alternate left and right along the duct), and optionally with larger mirrors with increasing distance away from the light source to provide uniform light output at each light output surface.

### Duct.

The duct may comprise a plurality of light output surfaces. In some embodiments, the light output surface is located on either one or a combination of the bottom surface, top surface or lateral surface of the duct relative to the duct's mounted position. Light output surfaces may be located not only at the bottom surface (opposite the surface facing the wall) of the duct, but may also be located on lateral sides of the duct. In some embodiments, sections of the duct may comprise a transparent material e.g. polycarbonate, or a white or colored translucent material, e.g. a white acrylic duct, or cast acrylic plexiglass duct, as may be dictated by aesthetic and practical considerations of the application. More generally, mirror-lined ducts may be used in the lighting system.

### Modular Construction.

In some embodiments, the light engine, duct and the collimator are made separately as modules, to be assembled during installation. As shown in FIG. 14, the light collimator 112 and the duct 140 comprising light output surfaces 150 may be produced separately from the light engine 110. The light engine 110 may also be modularized in to a driver circuit module 118 and heat sink module 116 with light source mounted, connectable via connector 133. The modularization of the lighting system components enables each module to be placed in accordance with the described embodiments. The light collimator 112 and the duct 140 may form a light collimation module 111, and is fitted onto the light engine 110 in accordance with arrows 113. Another duct 140 is fitted to the connector module in accordance with arrows 123. In order to ensure mating fit between sections, the light collimation module 111 and each duct 140 may be provided with a sleeve 143 at one end, and a flared section 149 at the other end. The sleeve 143 is designed to have a mating fit with the flared section 149 of the subsequent duct, enabling each duct to be coupled to the next duct readily. Snap-on fixtures, bolts and nuts, or latches, or any other securing means, may also be added (not shown) to enable ducts to be securely fastened to each other. This embodiment advantageously prevents light leak at the junctions of each duct as well. Manufacturing the lighting system in this modular fashion also facilitates production and installation.

### Light Collimator.

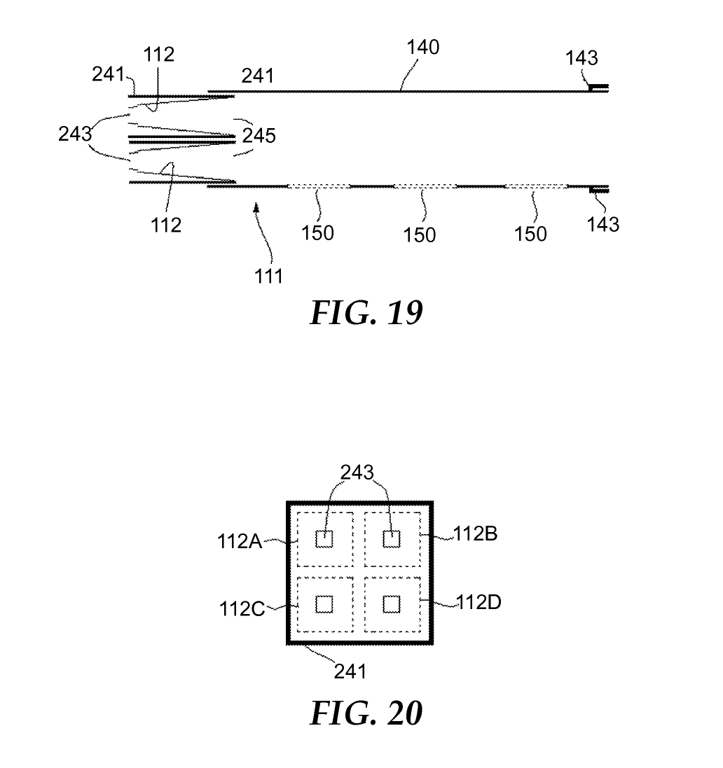

FIG. 19 shows a collimator module 111 in which a plurality of separate light collimators 112 are arranged together. Advantageously, for a given duct size, the use of a plurality of smaller light collimators bundled together enables a shorter light collimator to be used to achieve a more compact shape. Any suitable number of light collimators, such as 2, 4, 6 or 9 (or preferably n×n) light collimators, may be combined in this manner to achieve a shorter light collimator configuration without sacrificing performance. For example, a 6″ by 6″ duct may accommodate four 3″ by 3″ light collimators arranged in accordance with FIG. 20. Light entry surface 243 is fitted over light engine 110, and duct 140 is fitted over light output surface 245. FIG. 20 shows a top view of a bundled light collimator in which 4 light collimators (112A, 112B, 112C and 112D) are arranged in a 2×2 layout within a square shaped duct 241.

Although the present invention has been described with particular reference to preferred embodiments illustrated herein, it will be understood by those skilled in the art that variations and modifications thereof can be effected and will fall within the scope of this invention as defined by the claims thereto now set forth herein below.

1. A lighting system comprising:
a duct providing a light transport passage for transporting light along a propagation direction through the duct, the duct comprising a longitudinal axis and one or more light output surfaces through which light may be emitted,
a light collimator having an input end and an output end,
a light source arranged to direct light into the input end of the light collimator,
a heat sink thermally coupled to the light source, and
driver circuit for powering the light source,
wherein
at least one of the light collimator, light source, heat sink and driver circuit is arranged away from the longitudinal axis of the duct.

2-3. (canceled)

4. The lighting system of claim 1, wherein the light collimator, light source, heat sink and driver circuit are arranged away from the longitudinal axis of the duct.

5. The lighting system of claim 4, wherein the light collimator, light source, heat sink and driver circuit are arranged in a single file and at an angle of 90° to the longitudinal axis of the duct.

6. The lighting system of claim 4, wherein the light collimator, light source, heat sink and driver circuit are arranged in a single file and positioned parallel to the longitudinal axis of the duct.

7. The lighting system of claim 4, further comprising a joint connecting the light collimator to the duct.

8. The lighting system of claim 1, wherein the light source comprises an array of LEDs, said array of LEDs arranged on a first surface of the heat sink, and the driver circuit arranged on a second surface of the heat sink.

9. (canceled)

10. The lighting system of claim 1, wherein the light engine housing is thermally coupled to the heat sink and configured as a secondary heat sink.

11. (canceled)

12. The lighting system of claim 1, wherein the light collimator comprises a pyramidal or conical frustum.

13-14. (canceled)

15. The lighting system of claim 7, wherein the joint or bend is configured into a L-shape, T-shape or E-shape.

16. The lighting system of claim 1, further comprising a second light source arranged at an opposing end of the duct.

17. The lighting system of claim 1, wherein the duct comprises a plurality of light output surfaces, each light output surface comprising a multilayer optical stack comprising
a reflective layer arranged to face the duct, said reflective layer having one or more perforations for transmitting light,
a polished metal substrate layer having one or more perforations aligned to the perforations of the reflective layer,
and
one or more optical films arranged over the perforations for processing light leaving the duct.

18. The lighting system of claim 1, wherein the duct comprises a plurality of light output surfaces, each light output surface comprising one or more optical films.

19. The lighting system of claim 18, wherein the optical films are selected from one or a combination of a light turning film, a polarizing film, a reflective polarizing film, a brightness enhancement film, a day light film, and a light diffuser film.

20. The lighting system of claim 1, wherein the duct comprises a plurality of light output surfaces, each light output surface comprising a mirror capable of being actuated to a position at which light transmitted through the duct is incident on the mirror and reflected out of the duct.

21-23. (canceled)

24. The lighting system of claim 1, wherein a plurality of ducts are connected together, each duct comprising a sleeve section at one end and a flared section at the other end, the sleeve section of each duct capable of mating connection with the flared section of another duct.

25. A light collimation module comprising a light collimator coupled to a duct, the light collimation module usable in a lighting system comprising:
a duct providing a light transport passage for transporting light along a propagation direction through the duct, the duct comprising a longitudinal axis and one or more light output surfaces through which light may be emitted,
a light collimator having an input end and an output end,
a light source arranged to direct light into the input end of the light collimator,
a heat sink thermally coupled to the light source, and
driver circuit for powering the light source,
wherein
at least one of the light collimator, light source, heat sink and driver circuit is arranged away from the longitudinal axis of the duct.

26. The lighting system of claim 24, wherein the light collimator comprises a plurality of individual light collimators arranged together.

27. The light collimation module of claim 26, wherein the duct comprises a plurality of light output surfaces, each light output surface comprising one or more optical films selected from light turning films, polarizing films, reflective polarizing films, brightness enhancement films, and diffuser films.

28. The light collimation module of claim 26, wherein the duct comprises a mirror-lined duct.

29. The light collimation module of claim 28, wherein the internal surface of the mirror-lined duct has a light reflectance of at least 70%.
